(19) United States
(12) Patent Application Publication
(10) Pub. No.: US 2023/0007383 A1
(43) Pub. Date: Jan. 5, 2023

(54) HEADPHONE AND SPEAKER

(71) Applicant: YAMAHA CORPORATION, Hamamatsu-shi (JP)

(72) Inventors: Yuu TSUCHIHASHI, Hamamatsu-shi (JP); Yoshikazu HONJI, Hamamatsu-shi (JP); Masao NORO, Hamamatsu-shi (JP)

(21) Appl. No.: 17/939,363

(22) Filed: Sep. 7, 2022

Related U.S. Application Data
(63) Continuation of application No. PCT/JP2021/005220, filed on Feb. 12, 2021.

(30) Foreign Application Priority Data
Mar. 11, 2020 (JP) 2020-041642

(51) Int. Cl. H04R 1/10; H04R 3/04

(52) U.S. Cl. CPC H04R 1/1041; H04R 3/04; H04R 1/1008; H04R 1/1075; H04R 1/105

(57) ABSTRACT

A headphone includes: a housing; a first driver unit disposed in the housing; a partition wall dividing an internal space of the housing into a first space and a second space, the first space containing the first driver unit; a second driver unit attached to the partition wall; and an acoustic adjustment circuit configured to receive a first signal to be input to the first driver unit and generate a second signal to be input to the second driver unit based on the first signal.

### CROSS-REFERENCE TO RELATED APPLICATION

This application is a continuation application of International Application PCT/JP2021/005220 filed on Feb. 12, 2021, which claims priority from Japanese patent application JP2020-041642 filed on Mar. 11, 2020. The contents of these applications are incorporated herein by reference in their entirety.

### BACKGROUND

### 1. Field

This disclosure relates to a headphone and a speaker.

### 2. Description of the Related Art

A headphone is configured to convert electrical signals into sound by converting the electrical signals into vibration of a diaphragm of a driver unit and vibrating air with the diaphragm. Here, the air trapped inside a housing of the headphone serves as an air spring against the diaphragm, affecting acoustic characteristics. The acoustic characteristics are adjustable by using an acoustic tube (WO 2015/076006 and JP2019-103012).

A conventional method cannot achieve flexible tuning because of a narrow adjustment range of the acoustic characteristics.

### SUMMARY

This disclosure aims to flexibly adjust acoustic characteristics.

A headphone or a speaker includes: a housing; a first driver unit disposed in the housing; a partition wall dividing an internal space of the housing into a first space and a second space, the first space containing the first driver unit; a second driver unit attached to the partition wall; and an acoustic adjustment circuit configured to receive a first signal to be input to the first driver unit and generate a second signal to be input to the second driver unit based on the first signal.

This enables flexible adjustment of the acoustic characteristics by changing the volume of the first space.

### BRIEF DESCRIPTION OF THE DRAWINGS

FIG. 1 is an overall view of a headphone.

FIG. 2 is a plan view of a housing.

FIG. 3 is a III-III cross-sectional perspective view of the housing in FIG. 2.

FIG. 4 is a circuit diagram of an acoustic adjustment circuit.

FIG. 5 is a circuit diagram of an acoustic adjustment circuit according to Modification 1.

FIG. 6 is a circuit diagram of an acoustic adjustment circuit according to Modification 2.

FIG. 7 is a circuit diagram of an acoustic adjustment circuit according to Modification 3.

FIG. 8 is a circuit diagram of an acoustic adjustment circuit according to Modification 4.

FIG. 9 is a circuit diagram of an acoustic adjustment circuit according to Modification 5.

FIG. 10 is a circuit diagram of an acoustic adjustment circuit according to Modification 6.

FIG. 11 is a plan view of a speaker according to a second embodiment.

### DETAILED DESCRIPTION

Hereinafter, some embodiments will be described with reference to the drawings. Here, the invention can be embodied according to various aspects within the scope of the invention without departing from the gist of the invention and is not construed as being limited to the content described in the embodiments exemplified below.

### First Embodiment

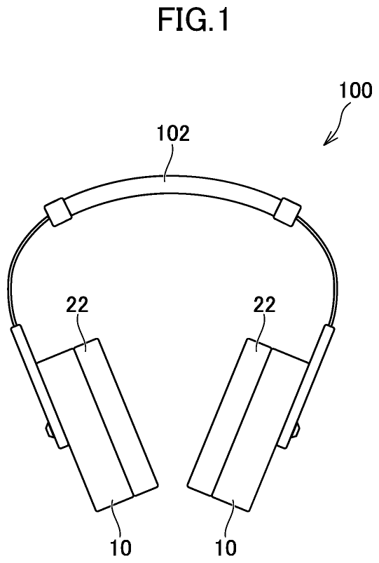

FIG. 1 is an overall view of a headphone. The headphone 100 is wired to or wirelessly connected to an unillustrated audio device (e.g., music player, sound mixer, smartphone). The headphone 100 has a headband 102 and a pair of housings 10. The headphone 100 may have a noise canceling function. An earphone shall be a kind of the headphone 100.

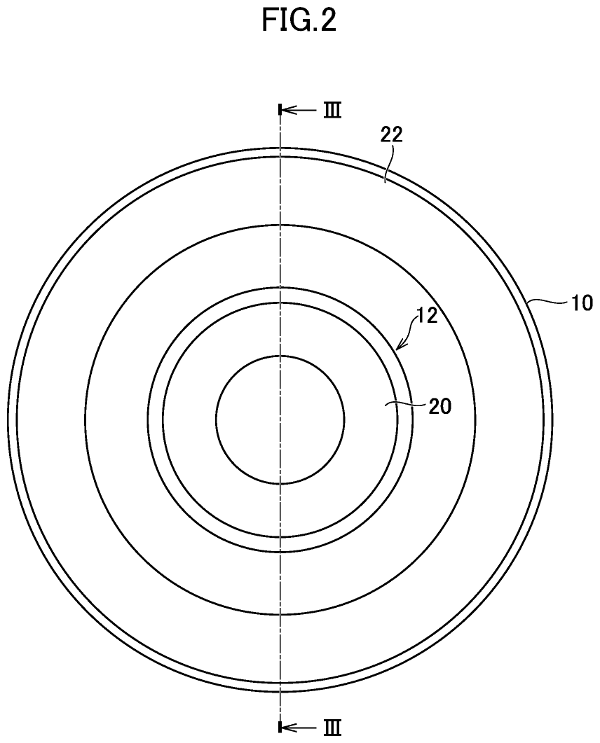

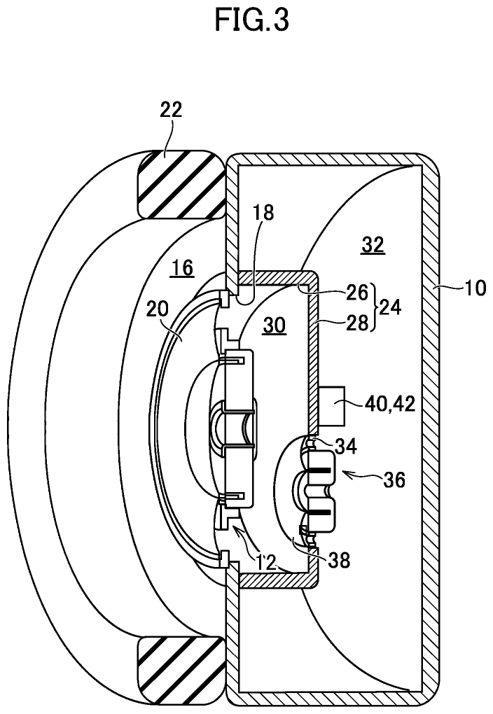

FIG. 2 is a plan view of the housing 10. FIG. 3 is a III-III cross-sectional perspective view of the housing 10 in FIG. 2. A first driver unit 12 is attached to the housing 10. The first driver unit 12 is configured to reproduce sound from electrical signals of original sound such as music. If it is a dynamic type, the sound is reproduced by passing an electric current through a coil based on the electric signals and vibrating a first diaphragm 20 by magnetic force.

The housing 10 has a first opening 18 in an output surface 16 opposed to a user's ear. The first diaphragm 20 of the first driver unit 12 is attached to the output surface 16 to block the first opening 18. An ear cup 22 is attached to the output surface 16, surrounding the first opening 18 and the first driver unit 12. In addition to the first opening 18, the housing 10 may have an aperture (port) for adjusting acoustic characteristics.

A partition wall 24 is attached to the housing 10. For example, the partition wall 24 is attached to a back of the output surface 16 and includes a side wall portion 26 enclosing the first driver unit 12 and a lid portion 28 closing a space enclosed by the side wall portion 26. The partition wall 24 covers the first driver unit 12. The partition wall 24 divides an internal space of the housing 10 into a first space 30, where the first driver unit 12 is located, and a second space 30. The first driver unit 12 faces the first space 30 and an external space.

The partition wall 24 (housing 10) has a second opening 34. The second diaphragm 38 of the second driver unit 36 is attached to the partition wall 24 to block the second opening 34. The second driver unit 36 faces both the first space 30 and the second space 32. The second driver unit 36 may have the same structure (e.g., dynamic type) as the first driver unit 12 or a different structure. The second driver unit 36 may be smaller than or the same in size as the first driver unit 12. Two or more second driver units 36 may block respective two or more second openings 34.

The first space 30 is a closed space because the first opening 18 and the second opening 34 are blocked by the first diaphragm 20 and the second diaphragm 38, respectively. The housing 10 (partition wall 24) has the closed space. The second diaphragm 38 is located between the first space 30 and the second space 32.

Since there is a first space behind the first diaphragm 20, air pressure in the first space affects vibration of the first diaphragm 20, thereby determining sound quality of the first driver unit 12. On the other hand, since the first space is in front of the second diaphragm 38, vibration of the second diaphragm 38 increases or decreases volume (capacity) of the first space, thereby changing the air pressure in the first space. In the housing 10 (e.g., between the partition wall 24 and the housing 10), an electrical board 40 is located.

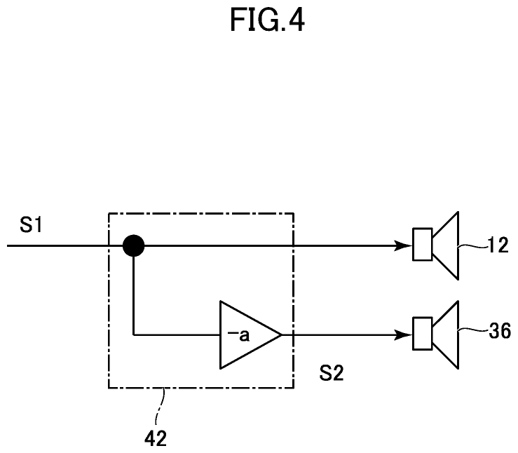

FIG. 4 is a circuit diagram of an acoustic adjustment circuit. An acoustic adjustment circuit 42 for driving the second driver unit 36 is included in the electrical board 40. The first driver unit 12 is configured to have a first signal S1 input thereto. The acoustic adjustment circuit 42 is configured to generate a second signal S2 based on the first signal S1. The second signal S2 is input to the second driver unit 36.

For example, the acoustic adjustment circuit 42 is configured to generate the second signal S2 in an opposite phase to the first signal S1 in a first band arbitrarily configurable. The first band is a frequency band in which sound pressure level is controlled to be lowered, and may be a partial frequency band or an entire frequency band. By setting the second signal S2 in the opposite phase to the first signal S1 in the first band, the first diaphragm 20 and the second diaphragm 38 vibrate in opposed directions or in opposite directions, so volume of the closed space (first space 30) changes much, increasing an impact of an air spring. This means that the sound pressure level of the first driver unit 12 can be lowered in the first band. This enables flexible adjustment of the acoustic characteristics.

### [Modification]

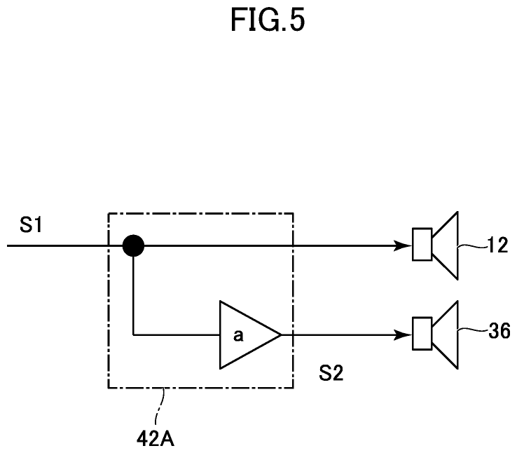

FIG. 5 is a circuit diagram of an acoustic adjustment circuit according to Modification 1. The acoustic adjustment circuit 42A is configured to generate the second signal S2 in the same phase as the first signal S1 in a second band arbitrarily configurable. The second band is a frequency band where the sound pressure level is controlled to be increased, and may be a partial frequency band or an entire frequency band. By making the second signal S2 in the same phase as the first signal S1 in the second band, the first diaphragm 20 and the second diaphragm 38 vibrate in the same direction, so the volume of the closed space (first space 30) changes little, decreasing the impact of the air spring. This means that the sound pressure level of the first driver unit 12 can be increased in the second band.

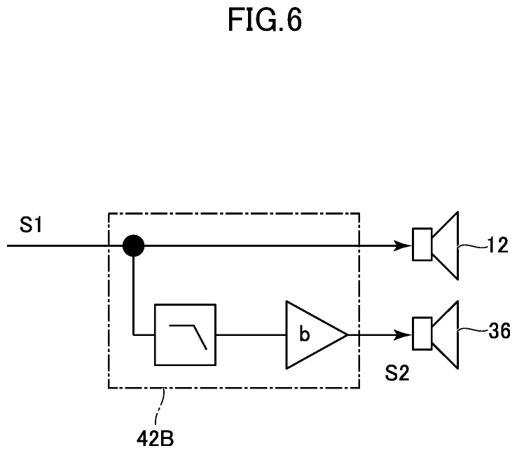

FIG. 6 is a circuit diagram of an acoustic adjustment circuit according to Modification 2. The acoustic adjustment circuit 42B includes a low pass filter. The second signal S2 is generated from a partial frequency band of the first signal S1. This enables adjustment of the acoustic characteristics at or below a cutoff frequency.

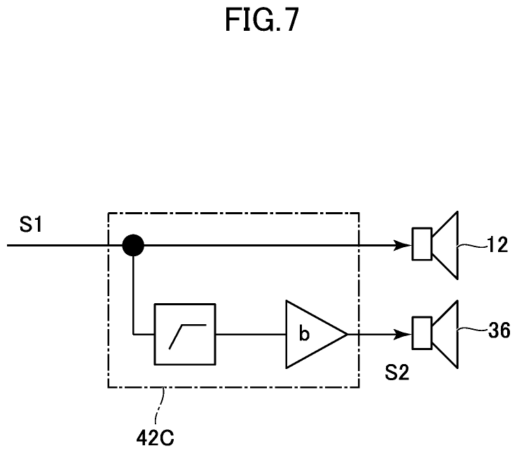

FIG. 7 is a circuit diagram of an acoustic adjustment circuit according to Modification 3. The acoustic adjustment circuit 42C includes a high pass filter. The second signal S2 is generated from a partial frequency band of the first signal S1. This enables adjustment of the acoustic characteristics at or above a cutoff frequency.

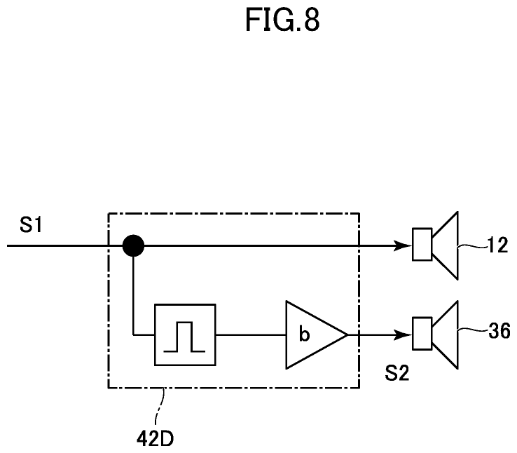

FIG. 8 is a circuit diagram of an acoustic adjustment circuit according to Modification 4. The acoustic adjustment circuit 42D includes at least one band pass filter. The second signal S2 is generated from a partial frequency band of the first signal S1. This enables adjustment of the acoustic characteristics in the band pass band.

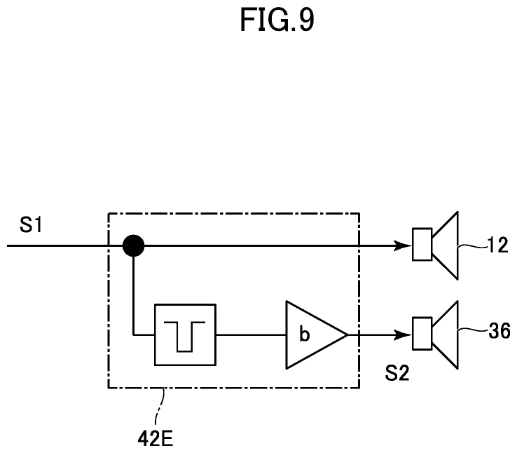

FIG. 9 is a circuit diagram of an acoustic adjustment circuit according to Modification 5. The acoustic tuning circuit 42E includes at least one band elimination filter (e.g., notch filter). The second signal S2 is generated from a partial frequency band of the first signal S1. This enables adjustment of the acoustic characteristics in the band pass band.

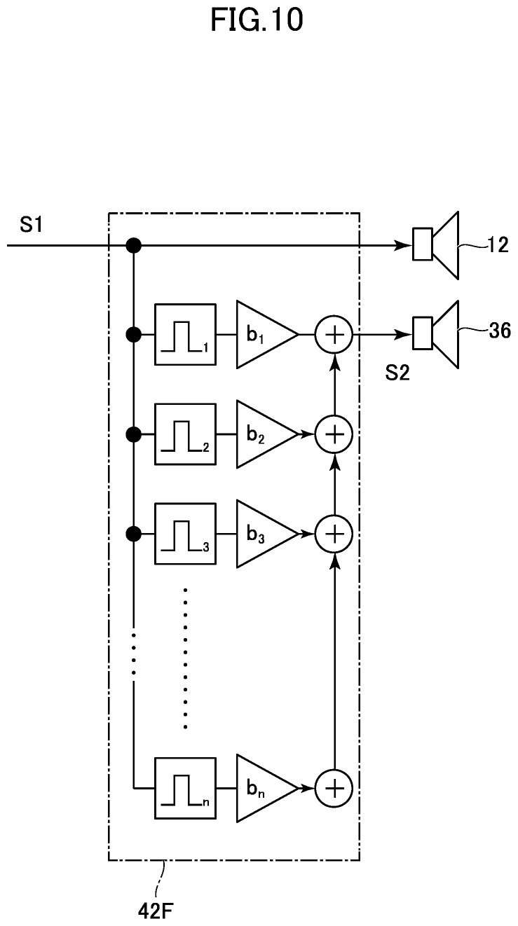

FIG. 10 is a circuit diagram of an acoustic adjustment circuit according to Modification 6. The acoustic adjustment circuit 42F includes multiple band pass filters. The second signal S2 is generated from multiple partial frequency bands of the first signal S1. This enables adjustment of the acoustic characteristics in multiple band pass bands. The multiple band pass bands may include a structural resonance frequency of the second driver unit 36.

### Second Embodiment

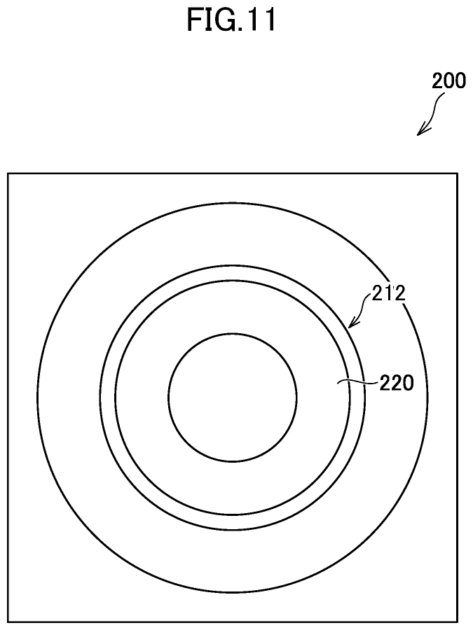

FIG. 11 is a plan view of a speaker in a second embodiment. The speaker 200 includes a first driver unit 212 with a first diaphragm 220. In addition, the speaker 200 includes the second driver unit, the housing, and the acoustic adjustment circuit, which are described in the first embodiment.

The invention is not limited to the embodiments described above and different variations are possible. The structures explained in the embodiments may be replaced with substantially the same structures and other structures that can achieve the same effect or the same objective.

What is claimed is:

1. A headphone comprising:
a housing;
a first driver unit disposed in the housing;
a partition wall dividing an internal space of the housing into a first space and a second space, the first space containing the first driver unit;
a second driver unit attached to the partition wall; and
an acoustic adjustment circuit configured to receive a first signal to be input to the first driver unit and generate a second signal to be input to the second driver unit based on the first signal.

2. The headphone according to claim 1, wherein the generated second signal is in an opposite phase to the first signal in a predetermined band.

3. The headphone according to claim 1, wherein the generated second signal is in the same phase as the first signal in a predetermined band.

4. The headphone according to claim 1, wherein the acoustic adjustment circuit includes a low pass filter.

5. The headphone according to claim 1, wherein the acoustic adjustment circuit includes a high pass filter.

6. The headphone according to claim 1, wherein the acoustic adjustment circuit includes at least one band pass filter.

7. The headphone according to claim 1, wherein the acoustic adjustment circuit includes at least one band elimination filter.

8. A headphone comprising:
a first housing;
a first driver unit disposed in the first housing;
a first partition wall dividing a first internal space of the first housing into a first space and a second space, the first space containing the first driver unit;
a second driver unit attached to the first partition wall;
a first acoustic adjustment circuit configured to receive a first signal to be input to the first driver unit and generate a second signal to be input to the second driver unit based on the first signal;
a second housing;
a third driver unit disposed in the second housing;
a second partition wall dividing a second internal space of the second housing into a third space and a fourth space, the third space containing the third driver unit;
a fourth driver unit attached to the second partition wall; and
a second acoustic adjustment circuit configured to receive a third signal to be input to the third driver unit and generate a fourth signal to be input to the fourth driver unit based on the third signal.

9. The headphone according to claim 8, further including a headband connecting the first and second housings.

10. The headphone according to claim 9, further including:
a first ear cup attached to the first housing; and
a second ear cup attached to the second housing.

11. A speaker comprising:
a housing;
a first driver unit, including a diaphragm, disposed in the housing;
a partition wall dividing an internal space of the housing into a first space and a second space, the first space containing the first driver unit;
a second driver unit attached to the partition wall; and
an acoustic adjustment circuit configured to receive a first signal to be input to the first driver unit and generate a second signal to be input to the second driver unit based on the first signal.
